(19) United States
(12) Patent Application Publication
(10) Pub. No.: US 2011/0244425 A1
(43) Pub. Date: Oct. 6, 2011

(54) UNIVERSAL HEALING ABUTMENT

(76) Inventor: Joseph Wiener, Vandalia, OH (US)

(21) Appl. No.: 13/159,997

(22) Filed: Jun. 14, 2011

Related U.S. Application Data
(63) Continuation-in-part of application No. 12/364,031, filed on Feb. 2, 2009.

(51) Int. Cl. A61C 8/00

(52) U.S. Cl. 433/173

(57) ABSTRACT

Universal dental healing abutments, kits for installing universal dental healing abutments, and methods of installing universal dental healing abutments are disclosed. The universal dental healing abutment may have a circumferential body attachable to a dental implant, and a crown attachable to the body. The body may have an upper section integral with a tapered lower section, and a central opening extending through the body. The kit may have a screw and a universal dental healing abutment. The method of installing may include surgically placing a dental implant into the jaw of a patient, selecting a circumferential body, inserting a tapered lower section of the body within the dental implant, attaching the circumferential body to the dental implant, and attaching a crown to the circumferential body such that the crown is out of occlusion.

This application is a continuation-in-part of U.S. application Ser. No. 12/364,031 filed Feb. 2, 2009, the contents of which are fully incorporated by reference herein.

### TECHNICAL FIELD

The present disclosure relates generally to healing abutments, and particularly to universal dental healing abutments, kits for installing universal dental healing abutments, and methods of installing universal dental healing abutments.

### BACKGROUND

Dental implants are commonly used in dental replacements and restorations. A dental implant is an artificial tooth root replacement which normally consists of a titanium screw (resembling a tooth root) with a roughened surface. Typical dental implant procedures involve the use of artificial components which include dental implants, abutments, and artificial crowns. A variety of manufacturers make dental implants, including, but not limited to Bicon Dental Implants, Biomet, BioHorizons, Bramemark, Nobel Biocare, Straumann, Osteocare, Osteo-Ti, 3i, Zimmer, Astra Tech, Ankylos, Implant Direct, Intra-Lock, Lifecore, Bio-Lol2zk and Diskimplant.

The process for restoring a tooth is usually carried out in stages, generally involving several surgeries over a period of months. During the first stage of the dental implant procedure, an osteotomy, or precision hole, is carefully drilled into the jawbone of a patient at edentulous (without teeth) sites in the jawbone. A dental implant is then installed into the osteotomy. Once properly torqued into the jawbone, a cover screw is placed on the dental implant and the gingiva or gum is sutured over the site. Following suturing, the site is allowed to heal for several months; during this time, the dental implant osseointegrates with the jawbone. While the site heals, the patient exhibits an unattractive gap in her teeth where a permanent crown of the implant will eventually be installed. While it is possible for dental professionals and/or laboratories to fabricate custom temporary abutments to fit over the cover screw and to fill the gap, such abutments are expensive in terms of both cost and time. As a result, temporary abutments are rarely used during the first stage of the dental implant procedure.

After what could be several months, a second stage of the dental implant procedure is performed. During the second stage, the dental implant is uncovered in another surgical procedure and a healing abutment is placed onto the implant. Typical healing abutments may protrude through the gingiva of the mouth and encourage the gingiva to grow in a scalloped shape which approximates the appearance of a natural tooth's gingiva. The healing abutments are usually made from a titanium alloy; as a result, healing abutments are usually silver in color. Consequently, the patient exhibits an unattractive silver post protruding from her teeth through the gum at the site of the dental implant. The titanium posts can be physically unappealing and visible to the eye for a period of time ranging from weeks to months. Once the gingiva resembles a natural tooth's gingiva, a third and final stage of the dental implant procedure is performed.

During the third stage of the dental implant procedure, a permanent crown will be fabricated, placed onto the implant, and locked into place.

Accordingly, additional embodiments for universal dental healing abutments are desired.

### SUMMARY

In one embodiment, a universal dental healing abutment comprising a circumferential body attachable to a dental implant is disclosed. The circumferential body comprises an upper section integral with a tapered lower section, and a central opening. The central opening extends through the circumferential body. When attached to the dental implant in the patient, the tapered lower section of the circumferential body is inserted within an opening in the dental implant and at least a portion of the upper section extends above the gingiva of the patient.

In another embodiment, a universal dental healing abutment comprising a body attachable to a dental implant in a patient is disclosed. The body approximates the natural appearance of a tooth and comprises a crown component integral with a tapered lower section and a central opening extending through the body. When attached to the dental implant in the patient, the tapered lower section of the body is inserted substantially within an opening in the dental implant, the crown component extends above the gingiva of the patient, and the crown component is out of occlusion.

In yet another embodiment, a method for installing a universal dental healing abutment is disclosed. The method comprises surgically placing a dental implant into the jaw of a patient, selecting a circumferential body based on the size of the dental implant, inserting a tapered lower section of the circumferential body within an opening of the dental implant, attaching the circumferential body to the dental implant, and attaching a crown to the upper section of the circumferential body. The circumferential body comprises an upper section integral with a tapered lower section, and a central opening extending through the circumferential body. The circumferential body is attached to the dental implant with a screw through the central opening and an opening in the dental implant. When attached to the dental implant, at least a portion of the upper section extends above the gingiva of the patient, and the crown is out of occlusion.

These and other features and advantages of these and other various embodiments according to the present disclosure will become more apparent in view of the drawings, detailed description, and claims provided that follow hereafter.

### BRIEF DESCRIPTION OF THE DRAWINGS

The following detailed description of the embodiments of the present disclosure can be best understood when read in conjunction with the following drawings, where like structure is indicated with like reference numerals, and in which:

FIG. 1 is a top perspective view of a universal dental healing abutment according to an embodiment of the present disclosure;

FIG. 1A is a bottom perspective view of a universal dental healing abutment with a ball component according to an embodiment of the present disclosure;

FIG. 1B is a section view taken along section line 1B-1B in FIG. 1;

FIG. 2 is a top perspective view of a universal dental healing abutment with a ball component according to an embodiment of the present disclosure;

FIG. 3 is a top perspective view of a universal dental healing abutment according to an embodiment of the present disclosure;

FIG. 3A is a section view taken along section line 3A-3A in FIG. 3;

FIG. 4 is a front view of a universal dental healing abutment attached to a dental implant osseointegrated into a jawbone of a patient wherein a cavity of the crown is filled with putty according to an embodiment of the present disclosure;

FIG. 4A is a section view taken along line 4A-4A in FIG. 4;

FIG. 5 is a front view of a universal dental healing abutment attached to a dental implant osseointegrated into a jawbone of a patient according to an embodiment of the present disclosure;

FIG. 5A is a section view taken along line 5A-5A in FIG. 5;

FIG. 6 is a top perspective view of a patient's mouth with a dental healing abutment attached to a dental implant according to an embodiment of the present disclosure;

FIG. 6A is a top perspective view of a patient's mouth with a dental healing abutment attached to a crown and attached to a dental implant according to an embodiment of the present disclosure;

FIG. 7 is a side perspective view of a universal dental healing abutment attached to a crown according to an embodiment of the present disclosure;

FIG. 7A is a section view taken along section line 7A-7A in FIG. 7;

FIG. 8 is a back perspective view of a universal dental healing abutment attached to a crown according to an embodiment of the present disclosure;

FIG. 9 is a top perspective view of a kit according to an embodiment of the present disclosure; and

FIG. 10 is a schematic illustration of a method of installing a universal dental healing abutment according to an embodiment of the present disclosure.

Skilled artisans appreciate that elements in the figures are illustrated for simplicity and clarity and have not necessarily been drawn to scale. For example, the dimensions of some of the elements in the figures may be exaggerated relative to other elements, as well as conventional parts removed, to help to improve understanding of the various embodiments of the present disclosure.

### DETAILED DESCRIPTION

The following terms are used in the present application:

As used herein, the term “universal” refers to a dental healing abutment which may be used with a substantial majority of commercially available dental implants. In one particular embodiment, the universal dental healing abutment may be attached to a substantial majority of commercially available dental implants.

As used herein, in the context of a universal dental healing abutment, the term “prepable” refers to a universal dental healing abutment which may be adapted to various sizes, shapes and/or positions. In one particular embodiment, the universal dental healing abutment is prepable such that a dental professional may adapt the universal dental healing abutment to various sizes, shapes and/or positions while attached to the dental implant within a patient's mouth.

As used herein, the term “occlusion” refers to contact between at least one tooth and at least one universal dental healing abutment in a patient's mouth. In one particular embodiment, occlusion refers to contact between at least one maxillary tooth and at least one universal dental healing abutment in a mandibular position in a patient. Alternatively, in another particular embodiment, occlusion refers to contact between at least one mandibular tooth and at least one universal dental healing abutment in a maxillary position in a patient.

Universal Dental Healing Abutment

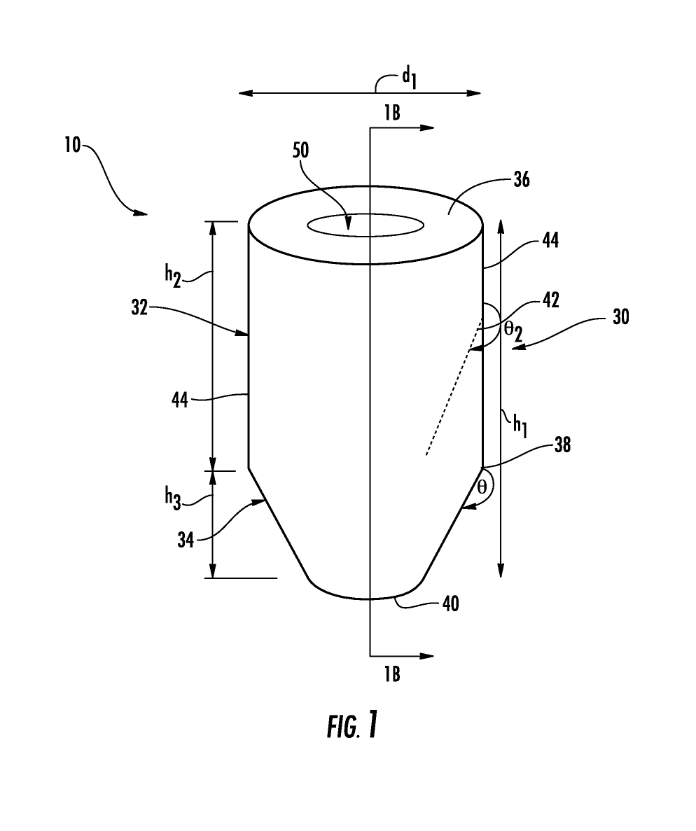

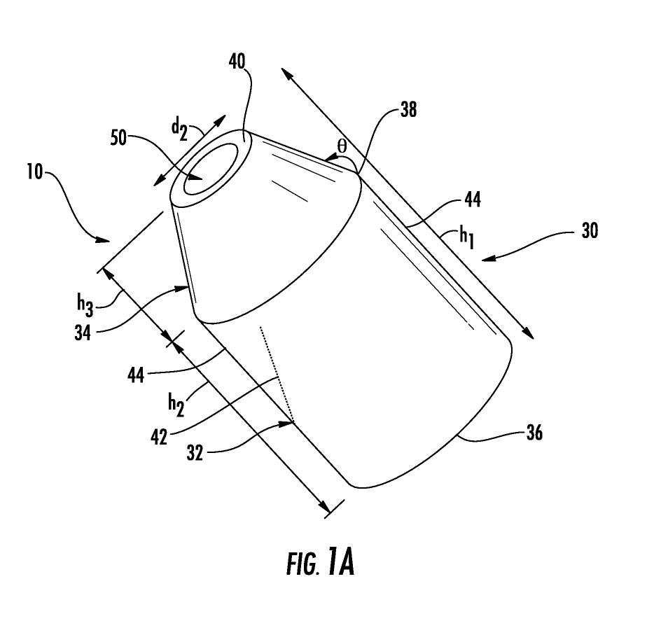

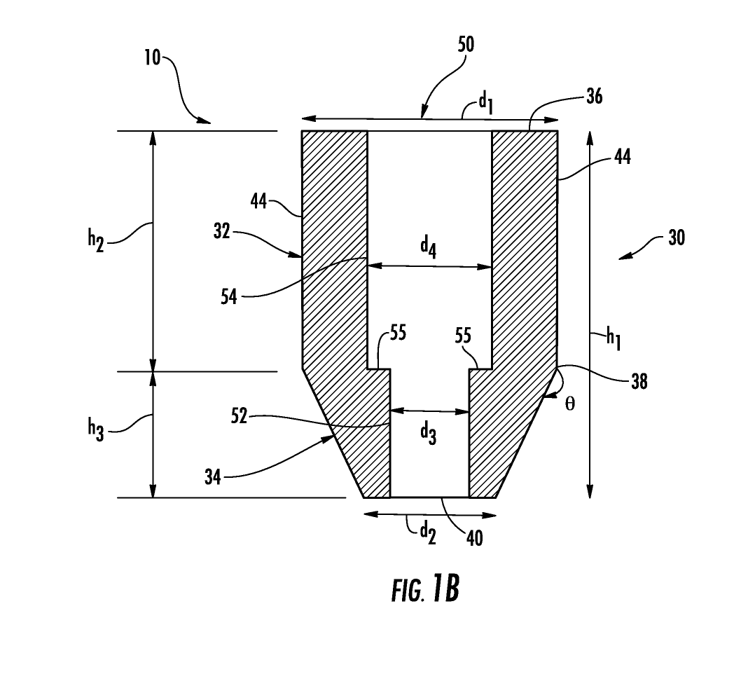

Embodiments of the present disclosure relate to universal dental healing abutments, kits for installing universal dental healing abutments, and methods of installing universal dental healing abutments. Referring to FIGS. 1, 2, and 3, in one embodiment, a universal dental healing abutment 10 is disclosed. The universal dental healing abutment 10 may comprise a circumferential body 30 attachable to a dental implant and a central opening 50 extending through the body 30.

Referring to FIGS. 1, 1A, and 1B, in one embodiment, the body 30 may comprise an upper section 32 integral with a tapered lower section 34. The upper section 32 and the tapered lower section 34 may comprise a substantially circular, oblong, or elliptical cross-sectional shape. In a further embodiment, the body 30 may comprise an upper surface 36, a middle surface 38, a lower surface 40, and an outer surface 44, wherein the upper section 32 extends from the upper surface 36 to the middle surface 38 and the tapered lower section 34 extends from the middle surface 38 to the lower surface 40. In one embodiment, the upper surface 36, middle surface 38, and the lower surface 40 may be substantially planar. The tapered lower section 34 may narrow from the middle surface 38 to the lower surface 40 such that the body 30 may comprise a substantially conical shape.

In one embodiment wherein the upper section 32 and the tapered lower section 34 comprise a substantially circular, oblong, or elliptical cross-sectional shape, the diameters, or lengths or widths, (as shown by double arrow d₁), of the upper surface 36 and the middle surface 38 may be from about 20% to about 60% greater than the diameter of the lower surface 40. The diameters (or lengths or widths) of the upper surface 36 and the middle surface 38 may be substantially the same (such as indicated by diameter d₁ in FIG. 1). In one particular embodiment, the diameters d₁ (or lengths or widths) of the upper surface 36 and the middle surface 38 may be from about 4 mm to about 6 mm, or from about 4 mm to about 5 mm, or from about 5 mm to about 6 mm. In a further embodiment, the diameters d₁ (or lengths or widths) of the upper surface 36 and the middle surface 38 may be about 4 mm.

In another particular embodiment, the diameter, or length or width, (as shown by double arrow d₂), of the lower surface 40 may be from about 2.5 mm to about 5 mm, or from about 2.5 mm to about 4 mm. In a further embodiment, the diameter d₂ (or length or width) of the lower surface 40 may be about 2.5 mm. In this particular embodiment, the diameter d₂ (or length or width) of the lower surface 40 may be less than the diameter d₁ of the upper section 32. The diameters d₁, d₂ (or lengths or widths) of the upper surface 36, middle surface 38, and lower surface 40 should not be limited to those disclosed herein, however, but may comprise any diameter (or length or width) wherein the body 30 is attachable to the dental implant as discussed in a later section.

In another embodiment, the overall height (as shown by double arrow h₁ and made up of the sub-heights h₂, h₃) of the body 30 may be about 9 mm. In one particular embodiment, the height h₂ of the upper section 32 may be about 7 mm and the height h₃ of the tapered lower section 34 may be about 2 mm. The heights h₁, h₂, h₃ of the body 30, upper section 32, and tapered lower section 34 should not be limited to those disclosed herein, however, but may comprise any heights wherein the body 30 is attachable to the dental implant.

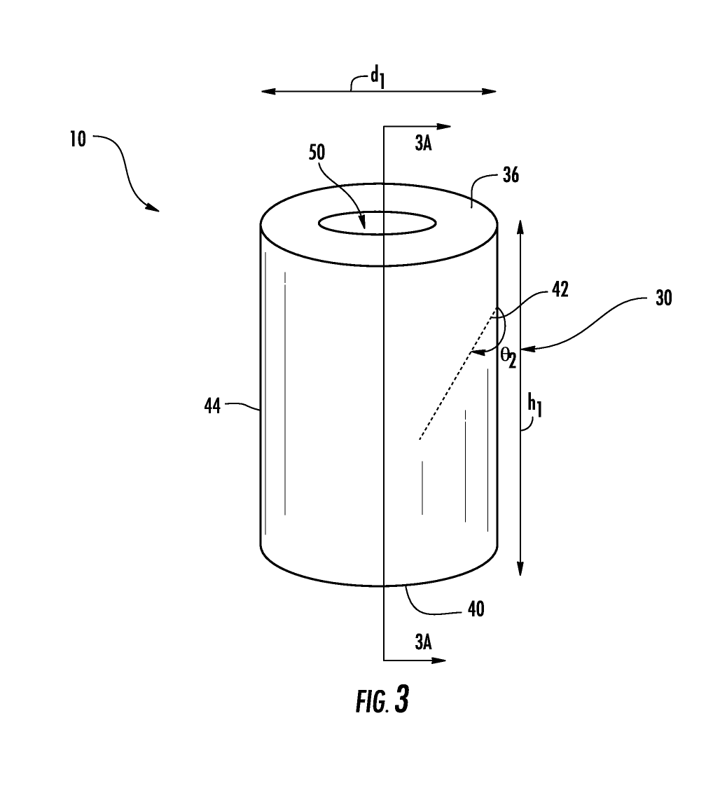

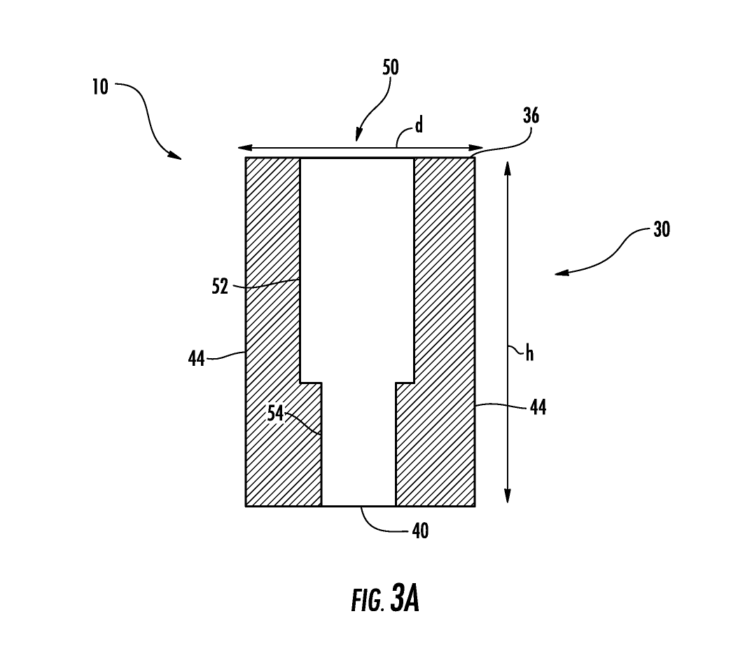

Referring to FIGS. 3 and 3A, in another embodiment, the body 30 may comprise a substantially circular, oblong, or elliptical cross-sectional shape. In a further embodiment, the body 30 may comprise an upper surface 36, a lower surface 40, and an outer surface 44. In one embodiment, the upper surface 36 and the lower surface 40 may be substantially planar. In this particular embodiment, the body 30 may comprise a substantially cylindrical shape.

In one embodiment wherein the body 30 comprises a substantially circular, oblong, or elliptical cross-sectional shape, the diameters, or lengths or widths, (as shown by double arrow d₁), of the upper surface 36 and the lower surface 40 may be substantially the same (such as indicated by diameter d₁ in FIG. 3). In one particular embodiment, the diameters d₁ (or lengths or widths) of the upper surface 36 and the lower surface 40 may be from about 4 mm to about 6 mm, or from about 4 mm to about 5 mm, or from about 5 mm to about 6 mm. In a further embodiment, the diameters d₁ (or lengths or widths) of the upper surface 36 and the lower surface 40 may be about 4 mm. In another embodiment, the overall height (as shown by double arrow h₁) of the body 30 may be about 9 mm. The height h₁ of the body 30 should not be limited to those disclosed herein, however, but may comprise any height wherein the body 30 is attachable to the dental implant.

In another embodiment, the body 30 may comprise a polymer and in one particular embodiment, the body 30 may comprise an organic thermoplastic polymer. In a further embodiment, the body 30 may comprise polyether ether ketone. In another embodiment, the body 30 may comprise a blend of a polymer and a radiocontrast agent, and, in one particular embodiment, the body 30 may comprise an organic thermoplastic polymer and a radiocontrast agent. In a further embodiment, the body 30 may comprise polyether ether ketone and barium sulfate. The radiocontrast agent is generally less than or equal to 10% by weight of the blend. The body 30 may comprise a radiocontrast agent such that it may be visible in X-ray images (and other diagnostic images). The body 30 should not be limited to the materials disclosed herein, however, but may comprise any material which is prepable and exhibits mechanical and/or chemical resistance properties typical of dental healing abutments.

In another embodiment, the body 30 may be prepable. The body 30 may be prepable such that the size, shape, and/or positioning of the body 30 may be adapted. In one particular embodiment, the size and/or shape of the body 30 may be adapted by techniques including drilling, grinding, shaving, cutting, contouring, shaping, and/or polishing. For example, referring to FIG. 1, the shape and/or size of the body 30 may be adapted to alter the angle of taper of the tapered lower section 34 (as shown by θ). More particularly, a dental professional may adapt the tapered lower section 34 to increase the angle of taper θ. In one particular embodiment, a dental professional may adapt the body 30 to provide an angle of taper θ of from about 10° to about 45°, or from about 15° to about 30°, or from about 20° to about 25°.

In another example, referring to FIGS. 1 and 3, the shape and/or size of the body 30 may be adapted to provide an angled surface 42 (as shown by dashed line 42). More particularly, a dental professional may adapt the body 30 to provide an angled surface 42. The angled surface 42 may form an angle θ₂ with the outer surface 44 of the upper section 32 wherein the angle θ₂ may be from about 5° to about 20°, or from about 10° to about 20°, or from about 15° to about 20°. In one embodiment, the angled surface 42 may provide proper alignment for a crown in instances wherein the dental implant is flared and/or the alignment of the dental implant is improper.

In yet another example, the size of the body 30 may be adapted to reduce the height h₁ of the body 30. More particularly, the height h₁ of the body 30 may be reduced such that when attached to a dental implant in a patient, the body 30 does not extend above the teeth adjacent thereto. In one particular embodiment, the height h₁ of the body 30 may be reduced such that it does not extend above the gingiva of the patient. In a further embodiment, the height h₁ of the body 30 may be reduced to about 3 mm.

In still yet another example, the positioning of the body 30 may be adapted. For example, when attaching the body 30 to a dental implant, the positioning of the body 30 may be adapted by rotating, angling, and/or translating the body 30 to align the body 30 with the teeth adjacent thereto. Adapting the size, shape, and/or positioning of the body 30 should not be limited to the techniques disclosed herein, but may include any techniques which may be used by dental professionals to adapt the size, shape, and/or positioning of the body 30.

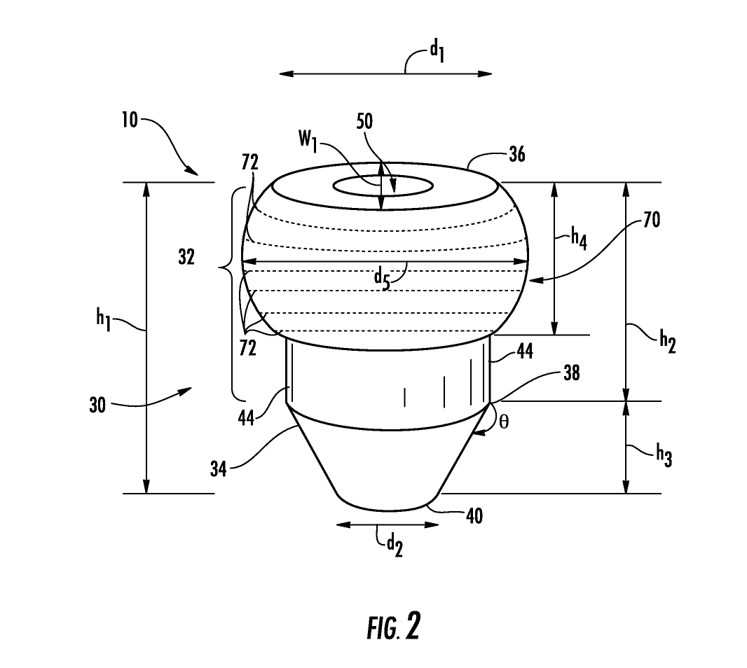

Referring to FIG. 2, in another embodiment, the body 30 may further comprise a ball component 70. In one embodiment, the ball component 70 may be an integral portion of the upper section 32 of the body 30. The ball component 70 may comprise retention grooves 72 over its external surface. In this particular embodiment, a dental professional may cut retention grooves (as shown by dashed lines 72) into the ball component 70. The retention grooves 72 can help secure the attachment of a crown to the universal dental healing abutment 10 (as discussed in a later section).

The ball component 70 may comprise a substantially circular, oblong, or elliptical cross-sectional shape. In one particular embodiment, the ball component 70 may comprise a maximum diameter d₅ (or length or width) of about 5 mm to about 6 mm, or about 5 mm reducing to a minimum diameter such as diameter d₁ (or length of width) of the upper surface 36. In another embodiment, the ball component 70 may comprise a height h₄ of about 3 mm to about 5 mm, or from about 4 mm to about 5 mm, or about 4 mm, which may be less than the height h₂ of the upper section 32, such as depicted in the illustrated embodiment. In still another embodiment, the height h₄ may be substantially equal to the height h₂. In non-circular embodiments, the ball component 70 may comprise a width w₁ which is perpendicular to diameter or length d₅, of about 3 mm to about 6 mm, or from about 4 mm to about 5 mm, or about 3 mm. However, the dimensions of the ball component 70 should not be limited to those disclosed herein, but may comprise any dimensions wherein the body 30 is attachable to a crown, as discussed in a later section.

Referring to FIGS. 1B and 3A, in another embodiment, the body 30 may comprise a central opening 50 which extends from the lower surface 40 to the upper surface 36, such that the central opening 50 extends through the height h₁ of the body 30. In one embodiment, the central opening 50 may comprise a lower section 52 integral with an upper section 54. In one particular embodiment, as shown in FIG. 1B, the lower section 52 may extend from the lower surface 40 to the middle surface 38 and the upper section 54 may extend from the middle surface 38 to the upper surface 36.

Referring again to FIGS. 1B and 3B, the lower section 52 and the upper section 54 may comprise a substantially circular cross-sectional shape. In a further embodiment, the lower section 52 and the upper section 54 may comprise different diameters (as shown by double arrows d₃, d₄). For example, the lower section 52 may comprise a diameter d₃ that is less than the diameter d₄ of the upper section 54. In one particular embodiment, the lower section 52 may comprise a diameter d₃ of from about 1 mm to about 2 mm, or from about 1.5 mm to about 2 mm, or about 1.6 mm. In another particular embodiment, the upper section 54 may comprise a diameter d₄ of about 2 mm to about 3 mm, or about 2 mm. However, the diameters d₃, d₄ of the lower section 52 and the upper section 54 should not be limited to those disclosed herein, but may comprise any diameters wherein the body 30 is attachable to the dental implant as discussed in a later section. In this particular embodiment, the central opening 50 may provide a landing 55. More particularly, the central opening 50 may provide a landing 55 wherein the lower section 52 meets the upper section 54. The landing 55 may be used for seating a head of a screw to fasten firmly the universal dental healing abutment 10 to a dental implant by a compressive fit.

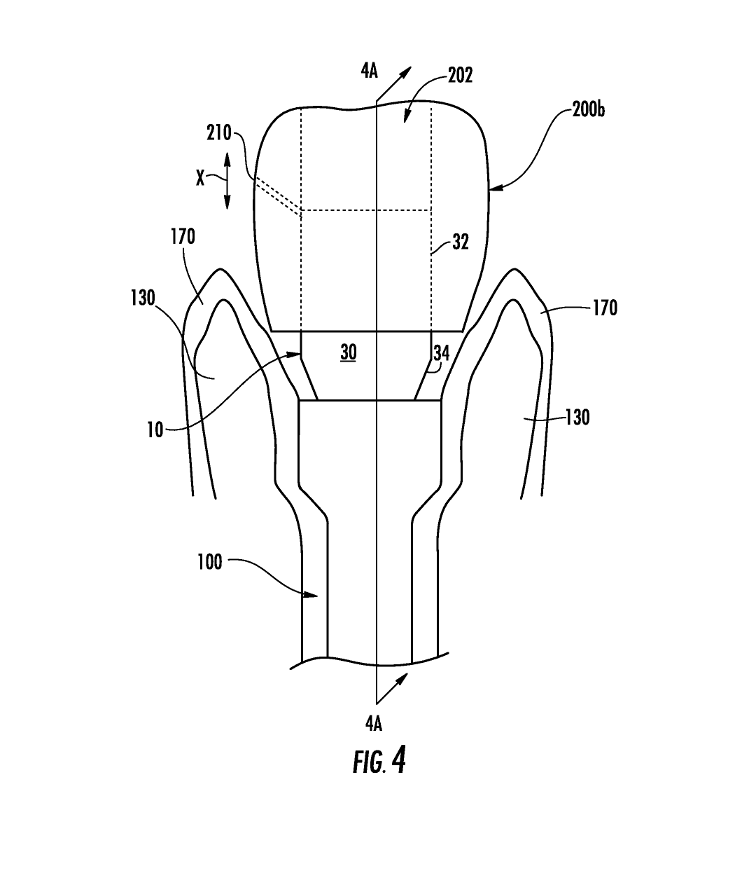

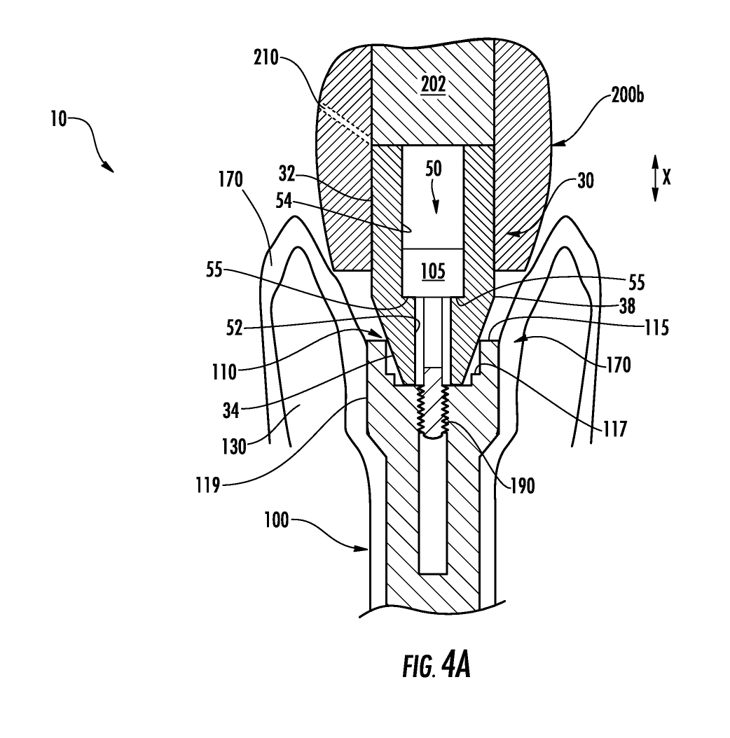

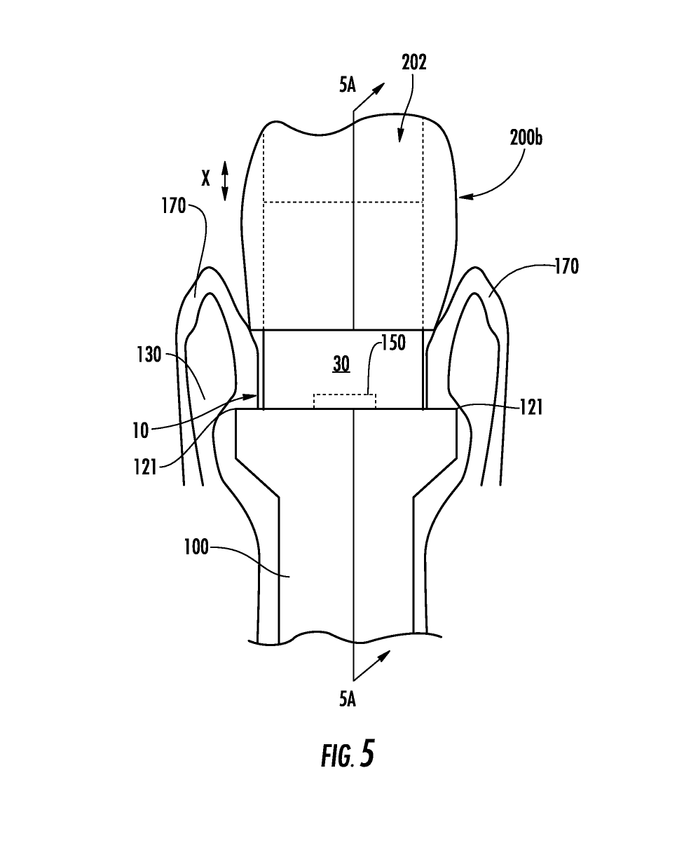

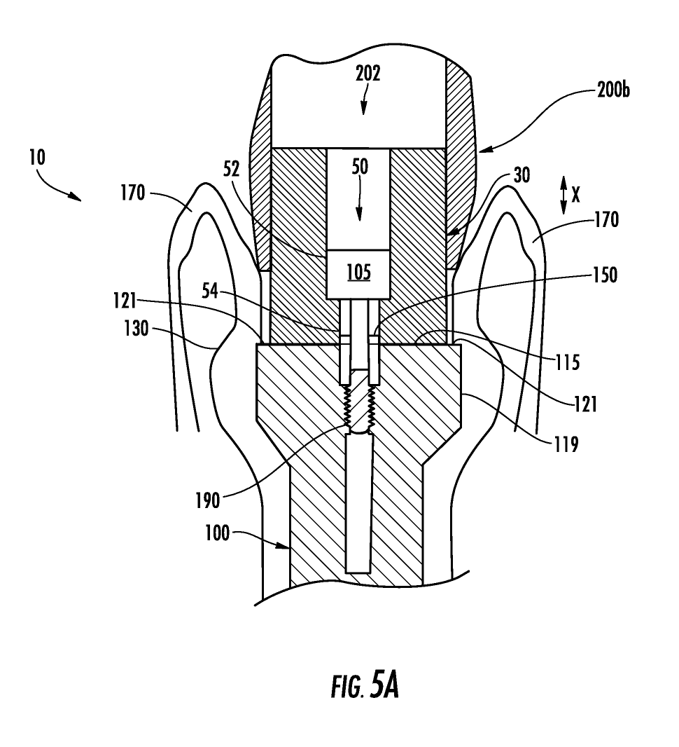

Referring to FIGS. 4 and 5, in another embodiment, the universal dental healing abutment 10 is attachable to a dental implant 100 in a patient. As discussed in an earlier section, a dental implant 100 may be osseointegrated into the jaw bone 130 of a patient during the first stage of a dental implant procedure. Also during the first stage, a cover screw may be placed on the dental implant 100, the gingiva 170 may be sutured over the site, and the site may be allowed to heal for several months. During the second stage, the dental implant 100 may be uncovered in another surgical procedure and the universal dental healing abutment 10 may be placed onto the dental implant 100. After securing thereon, a crown 200 is provided over the body 30, adjusted slidably up or down as indicated by arrow X, as needed, and then secured in place such as by a dental adhesive. In one particular embodiment, the crown 200 may be adjusted slidably up or down along the height of the portion of the body 30 which extends above the gingiva 170.

It is appreciated that the crown 200 may have a throughbore or a cavity 202 which slips over and accommodates the body 30 as desired. In this way, the crown 200 may directly contact the outer surface 44 of the body 30. In one embodiment, the body 30 is attachable to a dental implant 100 in a patient during the second stage of a dental implant surgical procedure subsequent to osseointegration.

Referring to FIG. 4A, in another embodiment, the body 30 is attachable to a dental implant 100 in a patient, such as via a screw 105, such that when attached to the dental implant 100, the tapered lower section 34 of the body 30 is inserted substantially within an opening 110 in the dental implant 100 and at least a portion of the upper section 32 extends above the gingiva 170 of the patient. In this way, at least a portion of the tapered lower section 34 may directly contact an inside surface 117 of the opening 110. The insertion of the tapered lower section 34 of the body 30 into the opening 110 of the dental implant allows the body 30 to self-align with the dental implant 100. The body 30 may self-align with the dental implant 100 such that the body 30 is in the proper position of attachment to the dental implant 100. In a further embodiment, the body 30 may self-align with the dental implant 100 such that the body 30 is in a proper position and/or orientation relative to the teeth of the patient. Furthermore, it is to be appreciated that the tapered lower section 34 has a diameter d₂ which bypasses any anti-rotational features that may have been provided on a top surface 115 of the dental implant 100, or as the inside surface 117 of the opening 110.

Referring to FIG. 5A, in another embodiment, the body 30 is attachable to a dental implant 100 in a patient, such as via a screw 105, such that when attached to the dental implant 100, the lower surface 40 of the body 30 abuts with at least a portion of the top surface 115 of the dental implant 100. In this particular embodiment, the lower surface 40 of the body 30 may sit around an outside surface of an anti-rotation device 150 on the top surface 115 of the dental implant 100. In this way, at least a portion of the lower surface 40 of the body 30 may directly contact the top surface 115 of the dental implant 100. The body 30 may directly contact the top surface 115 of the dental implant 100, such that it leaves a shoulder region 121 which may provide gingival support. The body 30 may be adjusted slidably up or down as indicated by arrow X, as needed, and then secured in place such as by a dental adhesive. By sitting around an outside surface of the anti-rotation device 150 of the dental implant 100, the body 30 bypasses the anti-rotation device 150 provided on the top surface 115 of the dental implant 100. In this way, the universal dental healing abutment 10 may bypass any provided anti-rotational features and be used with substantially all commercially available dental implants 100.

Referring to FIGS. 4A and 5A, the body 30 may be attached to the dental implant 100 through the central opening 50. In this embodiment, the body 30 may be attached to the dental implant 100 with a screw 105 which may be positioned through the central opening 50 of the body 30 and which may be threaded to threads 190 of the dental implant 100 through the opening 110 in the dental implant 100. As discussed in an earlier section, the head of the screw 105 may be seated on the landing 55 of the body 30 to fasten firmly the universal dental healing abutment 10 to a dental implant by a compressive fit. In this way, the screw 105 may sit adjacent to the inside surface 117 of the dental implant 100 adjacent to the threads 190. The screw 105 may be any screw 105 which is suitable for use with the particular dental implant 100. In this way, the universal dental healing abutment 10 may bypass any provided anti-rotational features and be used with a substantial majority of all commercially available dental implants 100, by simply providing the appropriate screw 105 for the used dental implant 100. In one particular embodiment, the universal dental healing abutment 10 may bypass any anti-rotational features such that it does not directly engage the anti-rotational features.

It is to be appreciated that anti-rotational devices are traditionally used to prevent dental abutments from loosening during use, for example, during chewing. As discussed in an earlier section, permanent crowns are fabricated and placed on dental implants and locked into place during the third stage of a dental implant procedure. Anti-rotational devices are typically used by dental professionals when affixing a permanent crown to the final abutment during the third stage of the dental implant procedure. Examples of anti-rotational devices typically used by dental professionals include, but are not limited to, internal hexagonal, external hexagonal, internal octagonal, and Moore taper. However, by directly screwing the body 30 of the universal dental healing abutment 10 to the dental implant 100, the universal dental healing abutment 10 may bypass the anti-rotation mechanism found in most dental implants 100. In one particular embodiment, insertion of the tapered lower section 34 of the body 30 into the opening 110 of the dental implant 100 bypasses the anti-rotation mechanism that may be provided in the top surface 115 or as a feature of the inside surface 117 of the dental implant 100. In another embodiment, sitting the body 30 around an outside surface of the anti-rotation device 150 bypasses the anti-rotation mechanism provided in the top surface 115 of the dental implant 100.

Examples of commercially available dental implants having such features to which the embodiment of the present disclosure may be used include those manufactured by Bicon Dental Implants, Biomet, BioHorizons, Bramemark, Nobel Biocare, Straumann, Osteocare, Osteo-Ti, 3i, Zimmer, Astra Tech, Ankylos, Implant Direct, Intra-Lock, Lifecore, Bio-Lok and Diskimplant. Additionally, in bypassing the anti-rotation mechanism found in most dental implants 100, the universal dental healing abutment 10 may be used with substantially all commercially available dental implants 100.

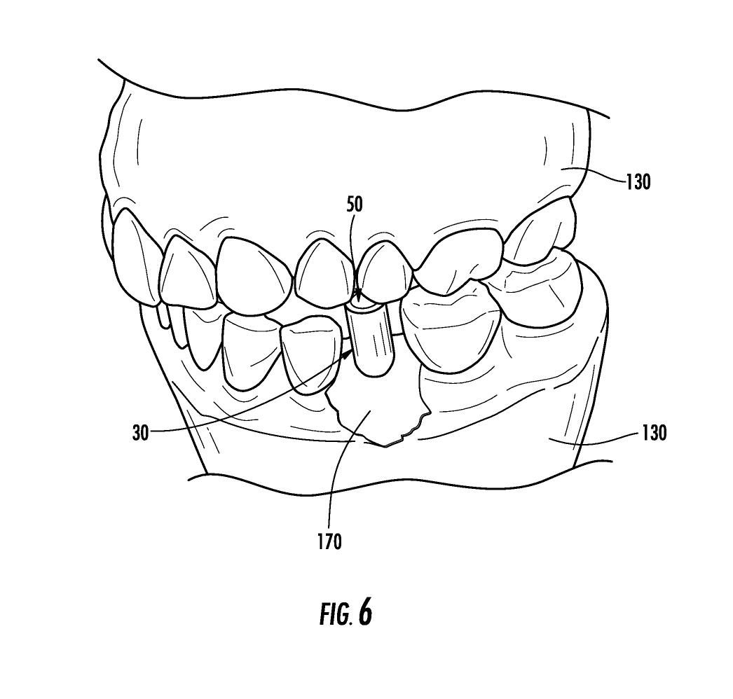

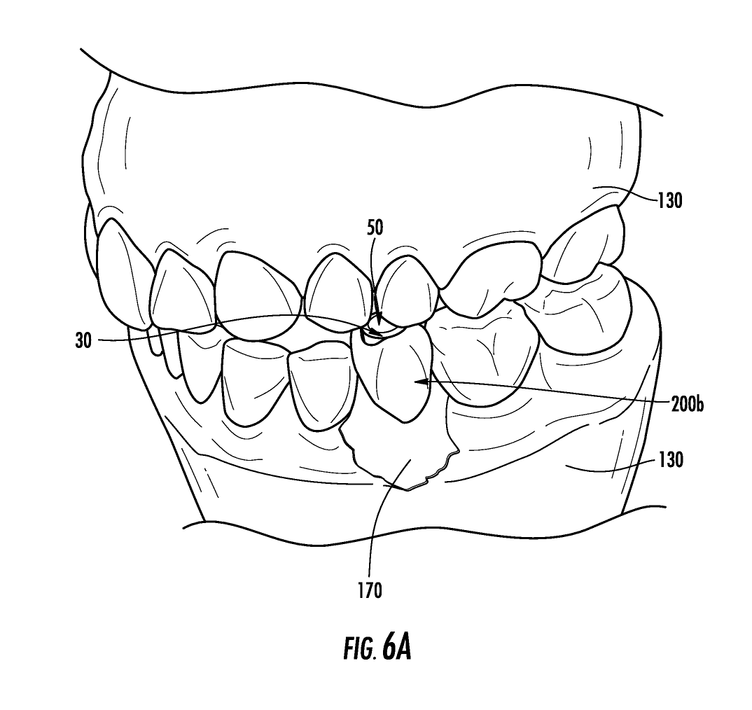

Referring to FIG. 6, in one embodiment, the body 30 is attachable to the dental implant 100 such that from about 50% to about 100% of the upper section 32 extends above the gingiva 170 of the patient. In another embodiment, the body 30 is attachable to the dental implant 100 such that from about 70% to about 90% of the upper section 32 extends above the gingiva 170 of the patient. In one particular embodiment, the body 30 is attachable to the dental implant 100 such that about 90% of the upper section 32 extends above the gingiva 170.

In another embodiment, the universal dental healing abutment 10 may provide gingival support to the patient. More particularly, the universal dental healing abutment 10 may support the gingival architecture throughout the healing phase by supporting and forming the gingival tissue. The size of the universal dental healing abutment 10 may be selected and the universal dental healing abutment 10 may be contoured by a dental professional to provide optimal support to the gingival architecture. For example, a dental professional may contour the size and/or shape of the body 30 to provide a scaffold from which the gingival tissue may form a natural scalloped shape. Accordingly, a dental professional may contour the universal dental healing abutment 10 to provide a shape most appropriate for forming the gingival tissue in a natural scalloped shape.

Referring to FIGS. 6A, 7, 8, and 9 in another embodiment, the body 30 is attachable to a crown 200. As previously discussed, the universal dental healing abutment 10 may be attached to a crown 200. Alternatively, the universal dental healing abutment 10 may be left free standing such that the abutment 10 may be optionally be attached to temporary apparatuses. In this particular embodiment, the size and/or shape of the abutment 10 may be adapted by techniques including drilling, grinding, shaving, cutting, contouring, shaping, and/or polishing, such that the abutment 10 does not extend substantially above the gingiva 170. For example, the abutment 10 may be adapted such that the abutment extends to approximately the level of the gingival 170. In this particular embodiment, the universal dental healing abutment 10 may be attached to flippers and/or Essex retainers. In this way, the abutment 10 provides an extensive amount of flexibility to dental professionals.

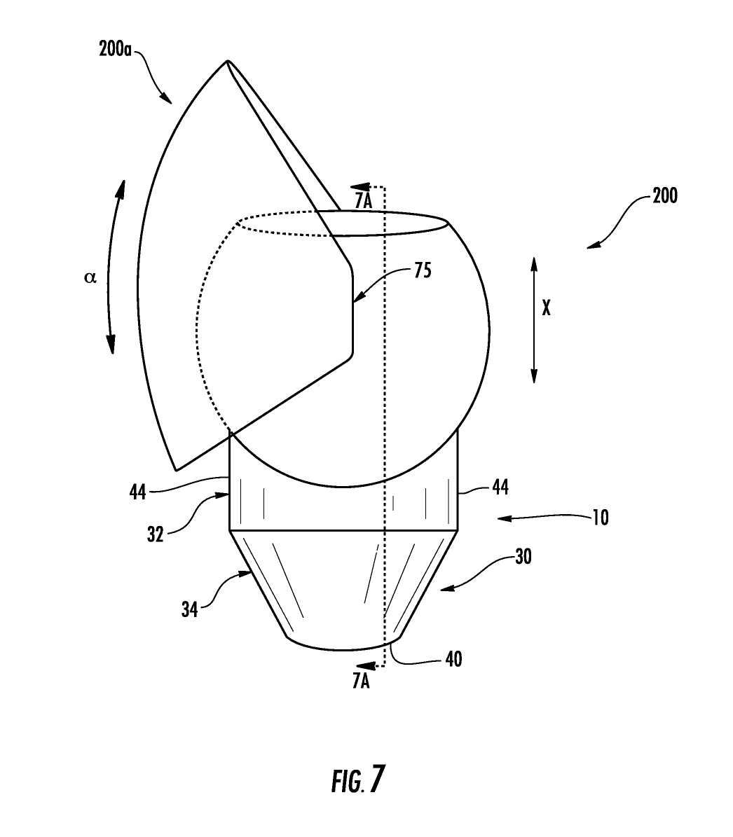

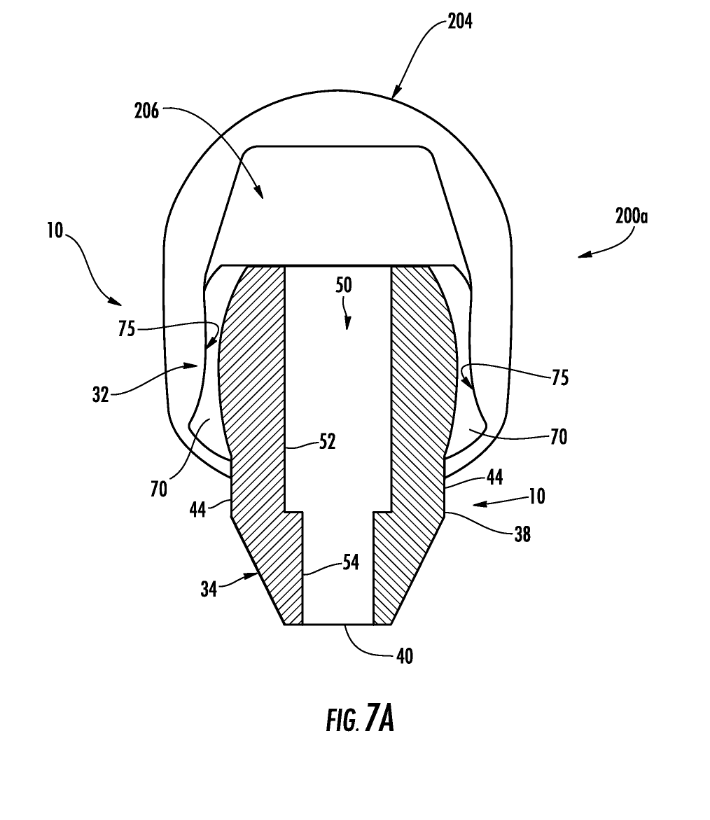

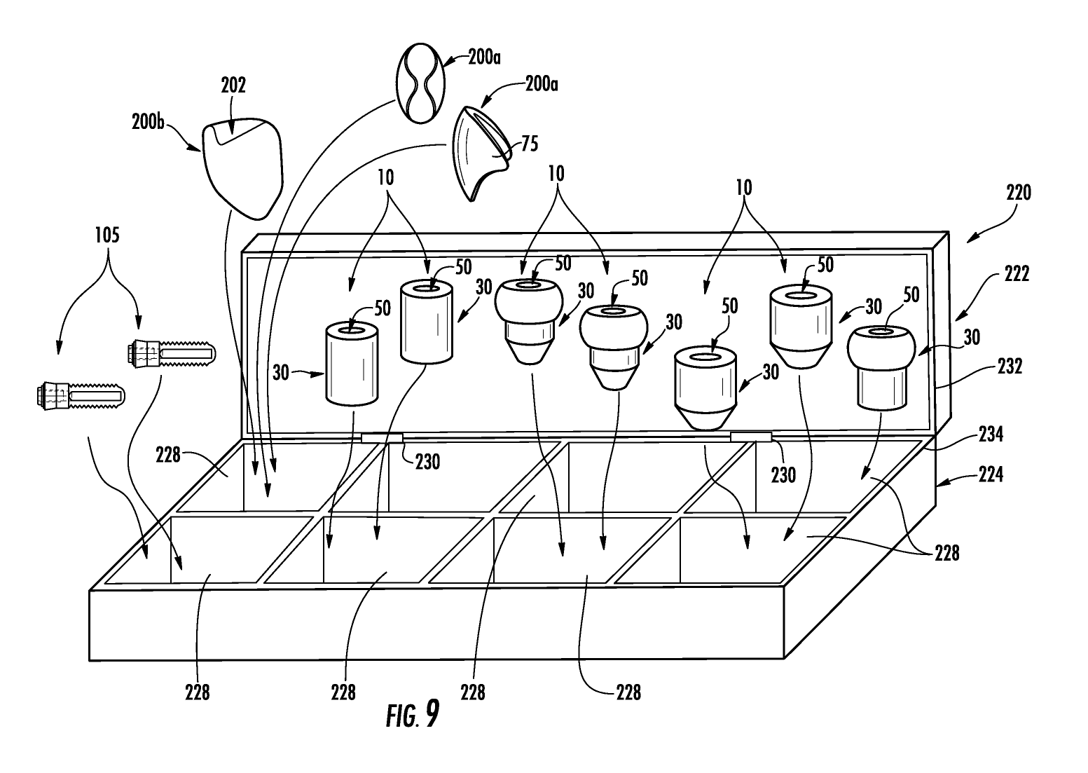

In one particular embodiment, the crown 200 approximates the natural appearance of a tooth. The crown 200 may approximate the natural appearance of an anterior tooth 200a or a posterior tooth 200b. As shown in FIGS. 7 and 9, in one particular embodiment, the anterior tooth 200a may comprise an open back 204 and an interior cavity/side 206. It is to be appreciated that the interior cavity/side 206 is shaped and sized to accommodate approximately greater than 50% of the circumferential surface of the ball component 70. In this manner, the crown 200 envelops a majority of the ball component 70 to facilitate the compressive fit of the snap-fit engagement.

The crown 200 may approximate the natural appearance of a tooth selected from the group consisting of incisors, canines, premolars, and molars. In a further embodiment, the body 30 is attachable to a crown 200 such that the crown 200 is out of occlusion. The crown 200 may comprise any commercially available and/or fabricated crown. In one particular embodiment, the crown 200 may comprise an open slot 210, the use of which is discussed in a later section.

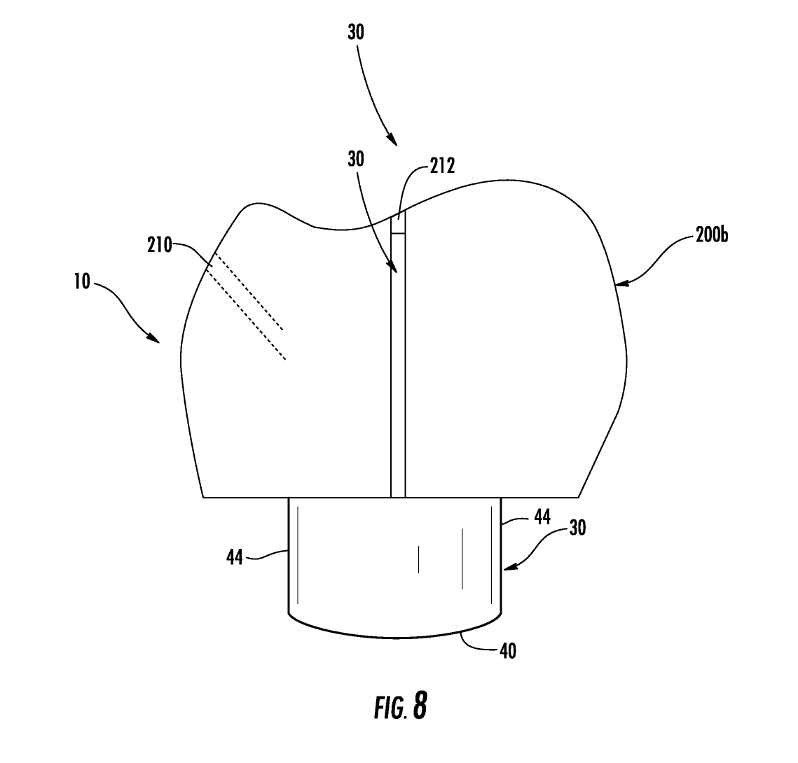

In another embodiment, the posterior tooth 200b may comprise a gap 212 which extends through the height of the posterior tooth 200b. The gap 212 provides a degree of flexability such that the posterior tooth 200b may flex to fit onto an universal dental healing abutment 10. As shown in FIG. 8, it is to be appreciated that the cavity 202 is shaped and sized to accommodate/envelop approximately 99% of the circumferential surface of the abutment 10 wherein the remainder is exposed through the gap 212. The gap 212 may also provide a degree of fitability such that the posterior tooth 200b may expand. In still another embodiment, the structures of the anterior tooth 200a and the posterior tooth 200b are adaptable. For example, the structure of the posterior tooth 200b may be transformed such that it mimics the shape of the anterior tooth 200a. More particularly, a portion of the posterior tooth 200b may be drilled, ground, shaved, cut, contoured, and/or shaped such that it mimics the shape of the anterior tooth 200a.

In one embodiment, the crown 200 is attachable to the upper section 32 of the body 30. In one embodiment, the crown 200 may be placed over the outer surface 44 of the body 30 which extends above the gingiva 170. In one particular embodiment, as shown in FIG. 4, a posterior tooth 200b may be placed over the upper section 32 of the body 30. In this particular embodiment, the posterior tooth 200b may be attachable to and/or attached to the upper section 32 of the body 30 with a compressive fit mechanism and/or a dental adhesive or luting agent. Examples of dental adhesives include, but are not limited to, self-curing polymers and epoxies. In one particular embodiment, the crown 200 may be attached to the upper section 32 of the body with a self-curing polymer.

Referring to FIGS. 7 and 7A, in another embodiment wherein the body 30 comprises a ball component 70, the crown 200 may be attachable to and/or attached to the upper section 32 of the body 30 via a snap-fit engagement. As used herein, the term “snap-fit engagement” refers to a degree of flexibility that the material of the crown 200 possesses such that the contact points/area 75 of the crown 200 compressively engage the ball component 70 of the abutment 10. Due to the snap-fit engagement, the crown 200 may be manually attached to and detached from the abutment 10, for instance by hand. Also due to the snap-fit engagement, the angling and positioning of the crown 200 may be manually adjusted, for instance by hand.

In one particular embodiment, an anterior tooth 200a comprising an open back 204 may be placed over only a portion of the outer surface 44 of the body 30 such that it does not wholly surround the outer surface 44 of the body 30. In one particular embodiment wherein the ball component 70 comprises retention grooves 72, the retention grooves 72 may help secure the attachment of a crown 200 to the universal dental healing abutment 10, such as via a friction fit. In this particular embodiment, the anterior tooth 200a may pivot in a labial (forward) direction or in a lingual (backward) direction about its snap fit with the body 30 (as indicated by tilt angle co). More particularly, the anterior tooth 200a may pivot substantially continuously from approximately 0° to approximately 20° in a labial or lingual direction. Alternatively, the anterior tooth 200a may pivot from approximately 5° to approximately 15°, or from approximately 8° to approximately 10° in a labial or lingual direction.

The crown 200 may also rotate about the ball component 70. For example, the crown 200 may rotate up to approximately 360° about the ball component 70. Alternatively, the crown 200 may rotate up to approximately 270°, or alternatively up to approximately 180°, or alternatively up to approximately 90° about the ball component 70. The crown 200 may also translate in an apical direction (e.g. “up”) or in a gingival direction (e.g. “down”) (as indicated by double arrow X). For example, the crown 200 may translate from about 1 mm to about 5 mm, or from about 1 mm to about 4 mm, or about 3 mm in the apical or gingival direction. However, it is understood by one of ordinary skill in the art that the crown 200 may translate in an apical or gingival direction along the height h₄ of the ball component 70 such that the crown 200 is attachable to and/or attached to the upper section 32 of the body 30 via a snap-fit engagement.

In an alternative embodiment, the body 30 may approximate the natural appearance of a tooth. In this particular embodiment, the body 30, like a crown 200, may approximate the natural appearance of a tooth, wherein the tooth is selected from the group consisting of incisors, canines, premolars, and molars. In one embodiment, the body 30 shaped like a crown 200 is provided integral with a tapered lower section 34 as discussed in an earlier section. The body 30 may also comprise an upper section 32, and a central opening 50 extending through the body 30 as discussed in an earlier section. The body 30 may also comprise additional features and may be attachable to the dental implant 100 as discussed in an earlier section.

Kit

Referring to FIG. 9, in another embodiment, a kit for installing a universal dental healing abutment 10 in a patient is disclosed. The kit may comprise at least one screw 105 and at least one universal dental healing abutment 10 as discussed in earlier sections. In a further embodiment, the kit may comprise at least one crown 200 as discussed in earlier sections. In still a further embodiment, the kit may comprise at least one universal dental transitional abutment as described in copending and commonly owned U.S. application Ser. No. 12/364,031, filed on Feb. 2, 2009, the contents of which are hereby incorporated by reference. In yet still a further embodiment, the kit may comprise a case 220 for accommodating the at least one screw 105 and the at least one universal dental healing abutment 10.

In one embodiment, the case 220 may comprise an upper housing 222 attached to a lower housing 224 for accommodating at least one screw 105 and/or at least one universal dental healing abutment 10. In one particular embodiment, the upper housing 222 may be hingedly attached to the lower housing 224 with a hinging mechanism 230. The case 220 may comprise an open configuration and a closed configuration (not shown).

In the open configuration (as shown in FIG. 9), the upper housing 222 is separated from the lower housing 224 such that the at least one screw 105 and/or the at least one universal dental healing abutment 10 is accessible in the lower housing 224. In one embodiment, the lower housing 224 may comprise a cavity 226 for accommodating the at least one screw 105 and/or the at least one universal dental healing abutment 10. In one particular embodiment, the lower housing 224 may comprise a plurality of compartments 228 for accommodating the at least one screw 105 and/or the at least one universal dental healing abutment 10. In a further embodiment, the lower housing 224 may comprise a plurality of compartments 228 for accommodating the at least one screw 105 and/or the at least one universal dental healing abutment 10. In one particular embodiment, the plurality of compartments 228 may comprise a substantially rectangular cross-sectional shape. However, it is understood that the plurality of compartments 228 may comprise any cross-sectional shape such that they may accommodate the screws 105 and/or universal dental healing abutments 10.

In the closed configuration, the surfaces 232, 234 of the upper and lower housings 222, 224 abut such that the screws 105 and/or universal dental healing abutments 10 are not accessible in the lower housing 224. In one embodiment, the case 220 may comprise a fastening mechanism (not shown) such that the case 220 may be releasably fixed in the closed configuration. The fastening mechanism may comprise a latching mechanism, a clamping mechanism, and/or a snap-fit mechanism.

In still another embodiment, the kit may further comprise any tools and/or adhesives necessary to attach the universal dental healing abutment 10 to a dental implant 100. In one particular embodiment, the tools and/or adhesives necessary to attach the universal dental healing abutment 10 to the dental implant 100 may include, but should not be limited to torque screwdrivers and/or dental adhesives. The dental adhesives may comprise any adhesives as discussed in an earlier section.

Method for Installing a Universal Dental Healing Abutment

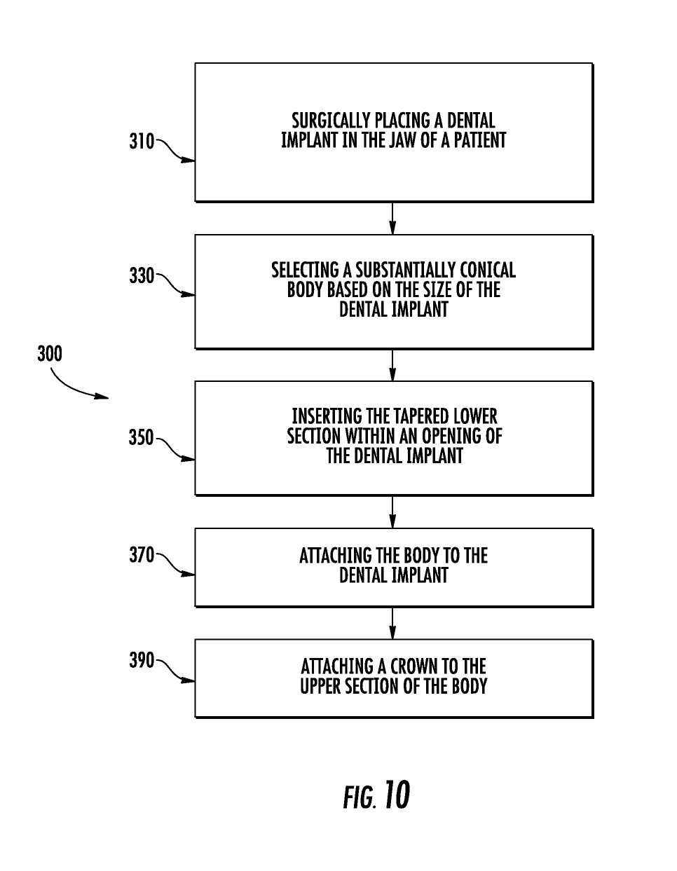

Referring to FIG. 10, in another embodiment, a method 300 for installing a universal dental healing abutment 10 is disclosed. The method 300 comprises surgically placing 310 a dental implant in the jaw of a patient, selecting 330 a circumferential body 30 based on the size of the dental implant 100, inserting 350 the tapered lower section 34 within an opening of the dental implant, attaching 370 the body to the dental implant, and attaching 390 a crown to the upper section of the body.

In step 310, a dental implant 100 is surgically installed into the jaw of a patient. During the second stage of the dental implant procedure, a dental professional can select a circumferential body 30 based on the size of the dental implant 100 in step 330. In another embodiment, the dental professional can select a body 30 which approximates the natural appearance of a tooth based on the size of the dental implant 100. Dental professionals may include, but should not be limited to, oral surgeons, periodontists, and/or general dentists.

The dental professional can then insert the tapered lower section 34 within an opening of the dental implant 100 in step 350. In this particular embodiment, the body 30 is self-aligning as discussed in an earlier section. However, if necessary, the dental professional can adapt the position of the body 30 by rotating, angling, and/or translating the body 30 within the dental implant 100 as discussed in an earlier section. The dental professional can also adapt the size, shape, and/or angle of taper θ of the body 30 by techniques including drilling, grinding, shaving, cutting, contouring, shaping, and/or polishing as discussed in an earlier section.

In an alternative embodiment, the dental professional can slip the body 30 over the outside surface 119 of the dental implant 100 in step 350. In this particular embodiment, at least a portion of the body 30 (such as the lower surface 40) abuts with at least a portion of the top surface 115 of the dental implant 100. In this particular embodiment, the lower surface 40 of the body 30 may sit around an outside surface of an anti-rotation device 150 on the top surface 115 of the dental implant 100. The body 30 may be adjusted slidably up or down as needed, and then secured in place such as by a dental adhesive as discussed in an earlier section.

Following step 350, the dental professional can attach the body 30 to the dental implant 100 in step 370. The dental professional can attach the body 30 to the dental implant 100 as discussed in an earlier section. In one particular embodiment, the dental professional can attach the body 30 to the dental implant 100 with a screw 105. Thus, prior to attaching the body 30 to the dental implant 100 the dental professional can choose the correct screw 105 for the dental implant 100. The dental professional can then screw the abutment 10 into place.

In this particular embodiment, the dental professional may apply a maximum force of about 20 Ncm. By torquing the universal dental healing abutment 10 to about 20 Ncm, a compressive fit may be achieved. In one embodiment, the compressive fit may prevent micro movement of the universal dental healing abutment 10 and may also prevent micro leakage between the universal dental healing abutment 10 and the dental implant 100. In another embodiment, wherein the body 30 is attached to the dental implant 100 with a screw 105 which is threaded through the central opening 50, the dental professional can fill in the central opening 50 through which the screw 105 was threaded.

Static and fatigue tests were performed to compare the substantially conical universal dental healing abutment to other standard universal transitional abutment (hereinafter “UTA”) systems. The static tests were conducted on eight analog systems using the substantially conical universal dental healing abutment with a diameter d₁ of about 5 mm. The abutments were installed onto commercially available dental implant analogs using the appropriate screws and the torque specified in Table I (provided below). A test fixture was used to hold the potted implant/abutment system about 30° off-axis. A hemispheric loading tip was designed such that the center of the contact point was about 8.0 mm above the implant interface in accordance with the ISO 14801 Test Method. Test loads were provided through the tip of the abutment by a stainless steel rod loaded through a small center drill point. During specimen bending action, the spherical abutment tip allowed the assembly to roll slightly while the pinned rods allow angular displacement, disallowing extraneous forces from being introduced. The testing equipment used included: 1) 20,000 Lb. Capacity Instron Model TTD universal testing machine using 100 lb. full scale range; 2) Krouse axial fatigue machines, Model ECN 1087; 3) 250 lb. strain gage load cell, S/N C26414 with an Ellis Associates Model BA-13 bridge/amplifier for dynamic load readout; and 4) Tohnichi 60 Ncm Torque Gage, Model 6BTG-N, Serial No. 501777K.

The same torque was used for both static and fatigue testing. All static testing was performed at room temperature in air. The results for static testing are disclosed in Table I below:

TABLE I

| | | | | |
|---|---|---|---|---|
| | | Implant | | |
| | | Analog/ | Screw | Max |
| | | Abutment | Torque | Load |
| ID | Description | Ref No. | (Ncm) | (lb.) |

Static Testing of 5 mm Substantially Conical Universal Dental
Healing Abutment on Implant Analogs

| | | | | |
|---|---|---|---|---|
| 4B-1 | Biomet ® 4.1 Analog & Screw | IILA20 | 20 | 54 |
| 3B-1 | Biomet ® 3.4 Analog & Screw | IMMILA | 20 | 54.25 |
| 5B-1 | Biomet ® 5 Analog & Screw | | | 54 |
| NC-1 | Straumann ® Bone Level NC | | 20 | 52 |
| | Analog & Screw | | | |
| RC-1 | Straumann ® Bone Level RC | | 20 | 57.25 |
| | Analog Astra Screw | | | |
| 3A-1 | Astra Tech 3.5/4.0 Implant Replica | 24276 | 20 | 46 |
| | & Screw | | | |
| Z-1 | Zimmer Implant Replica & Screw | PT344S | 20 | 50.25 |
| RP-1 | 3.5 Nobel Biocare ® Active RP | | 20 | 38.25 |
| | Analog & Screw | | | |

| | | | |
|---|---|---|---|
| — | 3.5 Nobel Biocare ® Select | | Conical UTA |
| | Tri-Lobe | | not compatible |
| — | Branemark Implant Replica | 31159 | Not applicable |
| | | | for conical UTA |
| — | Astra Tech 4.5/5.0 Implant Replica | 22509 | No compatible |
| | & Astra Tech abutment | | screw |

All fatigue testing was performed at room temperature air at 15 Hz. The results for fatigue testing are disclosed in Table II below:

TABLE II

| | | Max/Min | | |
|---|---|---|---|---|
| | | Load | Cycles to | Failure |
| ID | Description | (lb.) | Failure | Mode |
| 3A-2 | Astra Tech 3.5/4.0 Implant Replica | 30/3 | 1,000,000 | 1* |
| 3A-2 | Same sample increased load Astra | 35/3.5 | 59,100 | 2* |
| | Tech 3.5/4.0 Implant Replica | | | |
| RP-2 | 3.5 Nobel Biocare ® Active RP | 30/3 | 3,300 | 3* |
| | Analog | | | |
| Z-2 | Zimmer Implant Replica | 30/3 | 102,800 | 4* |

1* Test discontinued at 1 × 10⁶ cycles
2* Cracking of conical UHA
3* Screw failure
4* Cracking of implant replica

Upon attaching the abutment 10 to the dental implant 100, the dental professional can adapt the size, shape, and/or positioning of the abutment 10 as previously discussed in an earlier section. Optionally, the dental professional may cut retention grooves 72 into the body 30 of the abutment 10.

Finally, the dental professional can select a proper crown 200 for the dental abutment 10. For example, the dental professional can select a proper crown 200 with the correct size, shade, and mold to match the patient's teeth. The dental professional can then attach a crown 200 to the upper section 32 of the body 30 in step 310. Optionally, the dental professional can adjust the contacts of the crown 200 with the abutment 10 as needed, such that the crown 200 is properly aligned with the patient's teeth. The crown 200 can be rotated into its proper position as discussed in an earlier section. Also in this step, the dental professional can select a suitable luting agent to attach the crown 200 to the abutment 10. The luting agent may include a flowable light curing resin. For example, the luting agent may comprise, but should not be limited to Bis-acryl, ethyl methacrylate, and/or methyl methacrylate. Moreover, the luting agent may include any suitable resin materials known in the art.

Also in this step, the dental professional can also partially fill the crown 200 with the luting agent, taking care not to trap any excess luting agent within the cavity 202. After partially filling the crown 200 with a suitable luting agent, the dental professional can attach the crown 200 to the upper section 32 of the body 30 as discussed in an earlier section. Any excess luting agent can exit through the open slot 210 in the crown 200. Optionally, a cotton pellet and/or hemostat may be employed to prevent and/or remove any excess luting agent. The luting material can be set via any suitable techniques known in the art, including, but not limited to, light activation and/or self-activation.

Optionally, the dental professional can remove the partially cured crown 200 attached to the abutment 10 and attach to an implant analog. In this particular embodiment, removing the partially cured crown 200 allows the dental professional to easily handle and to prevent the luting agent from adhering to the screw 105. The dental professional may also backfill with the same luting agent of choice and may then polish the crown 200 prior to placing intraorally. The dental professional may then reattach the polished crown 200 and abutment 10 to the dental implant 100 within the patient's mouth as previously discussed. The dental professional may then fill the cavity 202 with putty. The putty may include any suitable material known in the art. This procedure may be completed in a very short period of time. For example, this procedure may be completed on the average of about five minutes.

Optionally, as previously discussed in an earlier section, the universal dental healing abutment 10 may be left free standing without a tooth form and may be modified accordingly. Also optionally, in one particular embodiment, steps 330-390 and all aspects of these steps as previously discussed, may be performed on an implant analog in a tissue analog model (e.g. outside of the patient's mouth).

For the purposes of describing and defining the present disclosure it is noted that the terms “about” and “substantially” are utilized herein to represent the inherent degree of uncertainty that may be attributed to any quantitative comparison, value, measurement, or other representation. The terms “about” and “substantially” are also utilized herein to represent the degree by which a quantitative representation may vary from a stated reference without resulting in a change in the basic function of the subject matter at issue.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The above description and drawings are only to be considered illustrative of exemplary embodiments, which achieve the features and advantages of the present disclosure. Modification and substitutions the features and steps described can be made without departing from the intent and scope of the present disclosure. Accordingly, the disclosure is not to be considered as being limited by the foregoing description and drawings, but is only limited by the scope of the appended claims.

What is claimed is:

1. A universal dental healing abutment comprising:
a circumferential body attachable to a dental implant in a patient, the circumferential body comprising an upper section integral with a tapered lower section, and a central opening extending through the circumferential body, such that:
when attached to the dental implant in the patient, the tapered lower section of the circumferential body is inserted substantially within an opening in the dental implant and at least a portion of the upper section extends above the gingiva of the patient.

2. The universal dental healing abutment of claim 1, wherein the circumferential body comprises an organic thermoplastic polymer and a radiocontrast agent.

3. The universal dental healing abutment of claim 2, wherein the circumferential body comprises polyether ether ketone and barium sulfate.

4. The universal dental healing abutment of claim 1, wherein the cross-sectional shape of the upper section is at least one of substantially circular, oblong, or elliptical, and the cross-sectional shape of the tapered lower section is at least one of substantially circular, oblong, or elliptical.

5. The universal dental healing abutment of claim 1, wherein the cross-sectional shape of the upper section is substantially circular and the cross-sectional shape of the tapered lower section is substantially circular such that the circumferential body comprises a substantially conical shape.

6. The universal dental healing abutment of claim 5, wherein the diameter of the upper section is from about 20% to about 60% greater than the diameter of the tapered lower section.

7. The universal dental healing abutment of claim 1, wherein the circumferential body is prepable.

8. The universal dental healing abutment of claim 1, wherein the circumferential body is attached to the dental implant through the central opening with a screw.

9. The universal dental healing abutment of claim 1, wherein the central opening comprises a lower section integral with an upper section, and a landing wherein the lower section and the upper section join.

10. The universal dental healing abutment of claim 9, wherein a portion of a screw is seated on the landing such that the circumferential body is attached to the dental implant by a compressive fit.

11. The universal dental healing abutment of claim 1, wherein the circumferential body is attached to the dental implant during the second stage of a dental implant surgical procedure subsequent to osseointegration.

12. The universal dental healing abutment of claim 1, wherein the attachment of the circumferential body to the dental implant provides gingival support to the patient.

13. The universal dental healing abutment of claim 1, wherein the attachment of the circumferential body to the dental implant bypasses an anti-rotation mechanism of the dental implant.

14. The universal dental healing abutment of claim 1, wherein the circumferential body is attachable to a crown and the crown approximates the natural appearance of a tooth.

15. The universal dental healing abutment of claim 14, wherein the crown is attachable to the circumferential body such that the crown is out of occlusion.

16. The universal dental healing abutment of claim 1, wherein the circumferential body further comprises a ball component integral with the upper section.

17. The universal dental healing abutment of claim 14, wherein the circumferential body is attachable to a crown approximating the natural appearance of a tooth via a snap-fit engagement.

18. A universal dental healing abutment comprising:
a body attachable to a dental implant in a patient, wherein the body approximates the natural appearance of a tooth and comprises a crown component integral with a tapered lower section and a central opening extending through the body, such that:
when attached to the dental implant in the patient, the tapered lower section of the body is inserted substantially within an opening in the dental implant, the crown component extends above the gingiva of the patient, and the crown component is out of occlusion.

19. The universal dental healing abutment of claim 18, wherein the body is prepable.

20. The universal dental healing abutment of claim 18, wherein the body is attached to the dental implant through the central opening with a screw and wherein the attachment of the body to the dental implant bypasses an anti-rotation mechanism of the dental implant.

21. A method for installing a universal dental healing abutment, the method comprising:
surgically placing a dental implant into the jaw of a patient;
selecting a circumferential body based on the size of the dental implant, wherein the circumferential body comprises an upper section integral with a tapered lower section, and a central opening extending through the circumferential body;
inserting the tapered lower section within an opening of the dental implant;
attaching the circumferential body to the dental implant with a screw through the central opening and an opening in the dental implant such that at least a portion of the upper section extends above the gingiva of the patient; and
attaching a crown to the upper section of the circumferential body such that the crown is out of occlusion.

22. The method of claim 20, further comprising adjusting the size of the circumferential body such that the circumferential body is out of occlusion.

23. The method of claim 21, further comprising adjusting the size of the circumferential body such that the circumferential body provides gingival support to the patient.

24. The method of claim 21, wherein the circumferential body is self-aligning upon insertion of the tapered lower section within the opening of the dental implant.

25. A kit for installing a universal dental healing abutment in a patient, the kit comprising:
at least one screw;
at least one crown; and
at least one of the universal dental healing abutments of claim 1.

26. The kit of claim 25, wherein at least one of the universal dental healing abutments further comprises a ball component integral with the upper section.

27. The kit of claim 25, further comprising at least one universal dental healing abutment comprising:
a circumferential body attachable to a dental implant in a patient, the circumferential body comprising a central opening extending through the circumferential body, such that:
when attached to the dental implant in the patient, the body sits around an outside surface of an anti-rotation device on a top surface of the dental implant.

28. The kit of claim 25, further comprising at least one universal dental transitional healing abutment.
